(19) United States
(12) Patent Application Publication
(10) Pub. No.: US 2015/0370817 A1
(43) Pub. Date: Dec. 24, 2015

(54) STORAGE STRUCTURE, AND INFORMATION STORAGE, READING, AND ADDRESSING METHOD

(71) Applicant: SHANGHAI XINHAO MICROELECTRONICS CO. LTD., Shanghai (CN)

(72) Inventor: KENNETH CHENGHAO LIN, Shanghai (CN)

(21) Appl. No.: 14/766,885

(22) PCT Filed: Jan. 29, 2014
(86) PCT No.: PCT/CN2014/071808

§ 371 Date: Aug. 10, 2015

(30) Foreign Application Priority Data
Feb. 8, 2013 (CN) 201310050840.4

(51) Int. Cl. G06F 17/30

(52) U.S. Cl. CPC G06F 17/30091; G06F 17/30339; G06F 17/30324; G06F 17/30106; G06F 17/30554

(57) ABSTRACT

A storage processing structure, a method of information storage, retrieving, and addressing are provided. The storage processing structure, the method of information storage, retrieving, and addressing employ a first storage table, a second storage table and comparators. Each line of the first storage table stores information in compressed sequential order to reduce the storage space requirement; the corresponding memory elements of the second storage table stores a representative value, this value can then be used to retrieve or address the information from the first storage table, to improve the speed of information retrieving and addressing.

### CROSS-REFERENCES TO RELATED APPLICATIONS

This application claims priority of Chinese Patent Application No. 201310050840.4, filed on Feb. 8, 2013, the entire contents of which are incorporated by reference herein.

### FIELD OF THE INVENTION

The present invention relates to the field of integrated circuits and computers, and in particular to a storage structure and information storage, retrieving, addressing method.

### BACKGROUND

Memory is the storage element of a computer system, in which program and data are kept, all the information in a computer, including raw data input, the computer program, intermediate results and final operation results are stored in memory. It stores and reads out information at its storage location specified by the controller. A computer functions only with memory.

Thus, information storage is essential to a computer system. Meanwhile, in order to realize its value, information has to be addressed and retrieve after its storage. Two points are crucial, for information storage technology, the first being the storage space required, as it ties the cost of the computer; the second being the addressing and retrieving speed, as it ties to the operation speed of the computer, a measure of the computer performance.

Therefore, a storage processing structure and method of information storage, retrieving, and addressing that satisfy the points afore mentioned have always been the pursuit.

### BRIEF SUMMARY OF THE DISCLOSURE

The purpose of the present invention is to provide a storage processing structure and method for information storage, retrieving, and addressing of the information in order to lower the storage space required for information storage, while also increasing the speed of retrieving and addressing the information.

This disclosure discloses a storage processing structure including: a first storage table, a second storage table and comparators, wherein: the first storage table comprises plurality storage elements organized in an array, the storage elements on each row stores information in a sequential order; the second storage table comprises plurality storage elements organized in an array, the second storage table has a same number of rows and columns as the first storage table, a memory element in the second storage table stores a representative value of the corresponding memory element in the first storage table; and the comparators compare newly arrived representative values with the representative values stored in the second storage table, the first storage table outputs the information corresponding to the newly arrived representative value based on the comparison result.

Optionally, the comparator compares the newly arrived representative value with the representative values stored in a row of the second table in parallel, and outputs a comparison result indicating “larger than”, “equal to” or “less than”; or indicating “larger than or equal” and “less than”; and a column address corresponding to the newly arrived representative value is acquired by monitoring different comparison results of adjacent comparators.

Optionally, information stored in the first storage table is data or instructions.

Optionally, information is stored using address, the address comprises a row address and a representative value; the information is stored in a first available memory element in a first storage table row indexed by a row address; and the representative value is stored in a corresponding second storage table element.

Optionally, the address of the information to be stored is stored in the first storage table.

Optionally, information is retrieved using address, the address comprises a row address and a representative value; the comparators compares the representative value in the address with representative values stored in a second storage table row indexed by the row address to generate a column address; and the first storage table outputs information in the memory element indexed by the row address and the column address.

Optionally, the column address of the larger representative value is selected as the column address corresponding to the representative value of the retrieving address if the representative value falls between two representative values of two adjacent columns of the second storage table; or the column address of the first column is selected as the column address corresponding to the representative value of the retrieving address if the representative value falls before the representative value of the first column of the second storage table; or a last column address plus one is selected as the column address corresponding to the representative value of the retrieving address if the representative value falls after the representative value of the last column of the second storage table.

Optionally, the column address of the smaller representative value is selected as the column address corresponding to the representative value of the retrieving address if the representative value falls between two representative values of two adjacent columns of the second storage table; or the column address of the first column minus one is selected as the column address corresponding to the representative value of the retrieving address if the representative value falls before the representative value of the first column of the second storage table; or the last column address is selected as the column address corresponding to the representative value of the retrieving address if the representative value falls after the representative value of the last column of the second storage table.

Optionally, the address of the addressing information includes a row address and a representative value; the comparators compare the representative values with the representative values stored in the second storage table to acquire a column address; and the row address and the column address are recorded for subsequent addressing.

Optionally, the representative value is retrieved from the second storage table based on the recorded row address and column address.

Optionally, the row address and column address are recorded in the first storage table.

Optionally, the structure further includes a third storage table, wherein the row address and column address are recorded in the third storage table.

Optionally, the column address of the larger representative value is selected as the column address corresponding to the representative value of the retrieving address if the representative value falls between two representative values of two adjacent columns of the second storage table; or the column address of the first column is selected as the column address corresponding to the representative value of the retrieving address if the representative value falls before the representative value of the first column of the second storage table; or the last column address plus one is selected as the column address corresponding to the representative value of the retrieving address if the representative value falls after the representative value of the last column of the second storage table.

Optionally, the column address of the smaller representative value is selected as the column address corresponding to the representative value of the retrieving address if the representative value falls between two representative values of two adjacent columns of the second storage table; or the column address of the first column minus one is selected as the column address corresponding to the representative value of the retrieving address if the representative value falls before the representative value of the first column of the second storage table; or the last column address is selected as the column address corresponding to the representative value of the retrieving address if the representative value falls after the representative value of the last column of the second storage table.

Optionally, the first storage table is a track table, a memory element of the track table stores a track address of a branch target instruction of a branch instruction stored in a memory, and a number of column of the track table is less than a number of instructions each memory row stores; and the second storage table is a mapping table, a memory element of the mapping table stores a representative value, which is the offset address of the branch instruction in the memory corresponding to a mapping table memory element.

Optionally, the row address corresponds to block address of instructions stored in the memory.

Optionally, the information stored in the memory element of the table includes memory address of memory element other than that of the track table.

Optionally, providing a first storage table and a second storage table, wherein the first storage table comprises plurality storage elements organized in an array, the second storage table comprises plurality storage elements organized in an array, the second storage table has a same number of rows and columns as in the first storage table; and acquiring an address of information being stored, the address comprises a row address and a representative value, wherein the information is stored in the first available memory element in the first storage table row indexed by the row address, wherein the memory element in the second storage table stores a representative value of the corresponding memory element in the first storage table.

Optionally, the first storage table stores the address of the information being stored.

Optionally, acquiring original content of the information being stored, wherein the original content comprises a row address and a representative value; providing comparators, wherein the comparators compare the representative value in the original value and the representative values stored in the second storage table to acquire a corresponding column address, wherein the first storage table stores the row address and the column address of the information being stored.

Optionally, the column address of the larger representative value is selected as the column address corresponding to the representative value of the original content if the representative value falls between two representative values of two adjacent columns of the second storage table; or the column address of the first column is selected as the column address corresponding to the representative value of the original content if the representative value falls before the representative value of the first column of the second storage table; or the last column address plus one is selected as the column address corresponding to the representative value of the original content if the representative value falls after the representative value of the last column of the second storage table.

Optionally, the column address of the smaller representative value is selected as the column address corresponding to the original content of the retrieving address if the representative value falls between two representative values of two adjacent columns of the second storage table; or the column address of the first column minus one is selected as the column address corresponding to the representative value of the original content if the representative value falls before the representative value of the first column of the second storage table; or the last column address is selected as the column address corresponding to the representative value of the original content if the representative value falls after the representative value of the last column of the second storage table.

This disclosure also discloses an information storage method. The method includes providing a first storage table, a second storage table and comparators, wherein the first storage table comprises plurality storage elements organized in an array, and storage elements on each row of the first storage table stores information in a sequential order; wherein the second storage table comprises plurality storage elements organized in an array, the second storage table has a same number of rows and columns as in the first storage table, and a memory element in the second storage table stores a representative value of the corresponding memory element in the first storage table; retrieving an address of information to be read, wherein the address comprises of a row address and a representative value; comparing, by comparators, the representative value of the retrieved address with the representative values stored in the second storage table to acquire a column address; and outputting, by the first storage table, the information corresponding to the row address in the retrieving address and the column address.

Optionally, the column address of the larger representative value is selected as the column address corresponding to the representative value of the retrieving address if the representative value falls between two representative values of two adjacent columns of the second storage table; or the column address of the first column is selected as the column address corresponding to the representative value of the retrieving address if the representative value falls before the representative value of the first column of the second storage table; or the last column address plus one is selected as the column address corresponding to the representative value of the retrieving address if the representative value falls after the representative value of the last column of the second storage table.

Optionally, the column address of the smaller representative value is selected as the column address corresponding to the representative value of the retrieving address if the representative value falls between two representative values of two adjacent columns of the second storage table; or the column address of the first column minus one is selected as the column address corresponding to the representative value of the retrieving address if the representative value falls before the representative value of the first column of the second storage table; or the last column address is selected as the column address corresponding to the representative value of the retrieving address if the representative value falls after the representative value of the last column of the second storage table.

This disclosure further discloses an information retrieving method, including: providing a first storage table, a second storage table and comparators, wherein the first storage table comprises plurality storage elements organized in an array, storage elements on each row of the stores information in sequential order; wherein the second storage table comprises plurality storage elements organized in an array, the second storage table has a same number of rows and columns as in the first storage table, and a memory element in the second storage table stores a representative value of the corresponding memory element in the first storage table; acquiring an address of information to be read, wherein the address comprises of a row address and a representative value; comparing, by the comparators, the representative value of the information address with the representative values stored in the second storage table to acquire a column address; outputting, by the first storage table, the information corresponding to the row address in the retrieving address and the column address; and recording the row address and the column address for subsequent addressing.

Optionally, the representative value is retrieved from the second storage table based on the recorded row address and column address.

Optionally, the row address and column address are recorded in the first storage table.

Optionally, the method further comprises a third storage table; the row address and column address are recorded in the third storage table.

Optionally, the column address of the larger representative value is selected as the column address corresponding to the representative value of the retrieving address if the representative value falls between two representative values of two adjacent columns of the second storage table; or the column address of the first column is selected as the column address corresponding to the representative value of the retrieving address if the representative value falls before the representative value of the first column of the second storage table; or the last column address plus one is selected as the column address corresponding to the representative value of the retrieving address if the representative value falls after the representative value of the last column of the second storage table.

Optionally, the column address of the smaller representative value is selected as the column address corresponding to the representative value of the retrieving address if the representative value falls between two representative values of two adjacent columns of the second storage table; or the column address of the first column minus one is selected as the column address corresponding to the representative value of the retrieving address if the representative value falls before the representative value of the first column of the second storage table; or the last column address is selected as the column address corresponding to the representative value of the retrieving address if the representative value falls after the representative value of the last column of the second storage table.

A storage processing structure, a method of information storage, retrieving, and addressing are provided. The storage processing structure, the method of information storage, retrieving, and addressing employ a first storage table, a second storage table and comparators. Each line of the first storage table stores information in sequential order to reduce the storage space requirement; the corresponding memory elements of the second storage table stores a representative value, this value can then be used to retrieve or address the information from the first storage table, to improve the speed of information retrieving and addressing.

### BRIEF DESCRIPTION OF THE DRAWINGS

FIG. 1a illustrates a schematic diagram of an exemplary implementation for a storage structure consistent with the disclosed embodiment 1;

FIG. 1b illustrates an alternative schematic diagram of an exemplary implementation for a storage structure consistent with the disclosed embodiment 1;

FIG. 2a illustrates the storage format comparison of existing memory and the memory structure of this invention;

FIG. 2b illustrates an alternative of the storage format comparison of existing memory and the memory structure of this invention;

FIG. 3 illustrates a schematic diagram of an exemplary implementation for a storage structure consistent with the disclosed embodiment 2;

FIG. 4 illustrates a schematic diagram of an exemplary implementation for a storage structure consistent with the disclosed embodiment 3; and

FIG. 5 illustrates a schematic diagram of an exemplary implementation for a storage structure consistent with the disclosed embodiment 4.

### DETAILED DESCRIPTION

Reference will now be made in detail to exemplary embodiments of the invention, which are illustrated in the accompanying drawings. The same reference numbers may be used throughout the drawings to refer to the same or similar parts. It is understood that the various components are listed for illustrative purposes, other components may be included and certain components may be combined or omitted.

### Embodiment 1

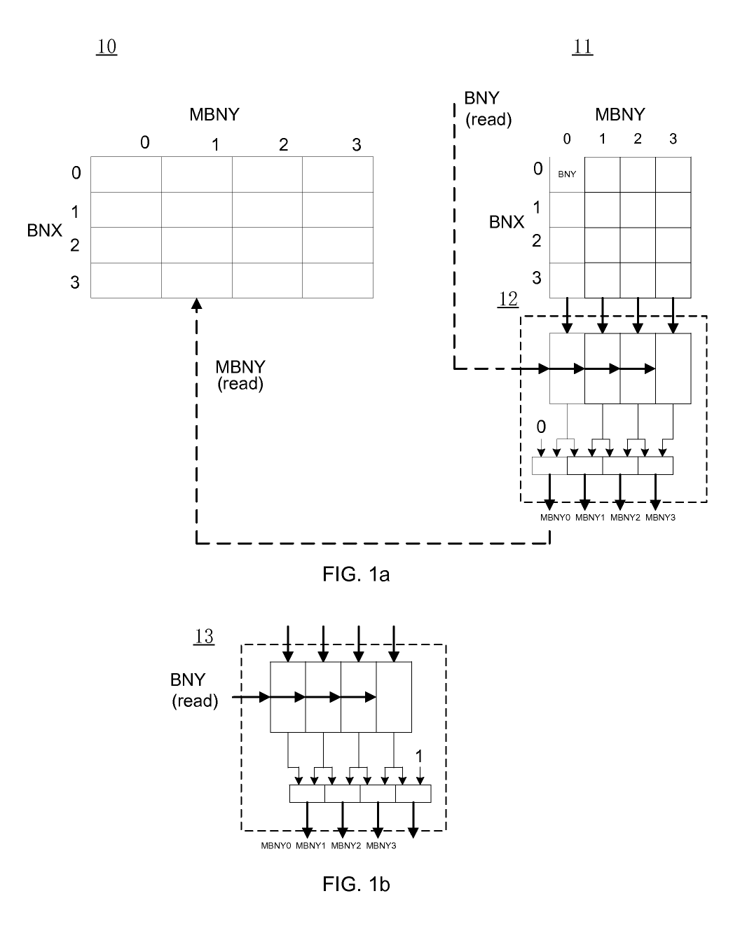

FIG. 1a illustrates a schematic diagram of an exemplary implementation for a storage structure consistent with the disclosed embodiment 1. As shown in FIG. 1a, the storage structure may include a first storage table 10, a second storage table 11 and a comparator 12; wherein, said first storage table 10 includes a plurality of memory cells arranged in an array, each row of memory cells store information in sequential order; the second storage table 11 includes a plurality of memory cells arranged in an array; the said second storage table 11 and the said first storage table 10 have the same number of rows and columns; the memory cell of the second storage table 11 stores the representative value of the corresponding cell of the first storage table 10; the comparators 12 compared the newly arrived representative values with the representative values stored in the second storage table 11; first storage table 10 outputs the information it stores corresponding to the newly arrived representative value based on the comparison result.

In this embodiment, the first storage table 10 is illustrated in a 4×4 configuration, that is the said first storage table 10 has 4 rows and 4 columns, with a total of 16 memory cells; similarly, the said second storage table 11 has the same 4×4 structure.

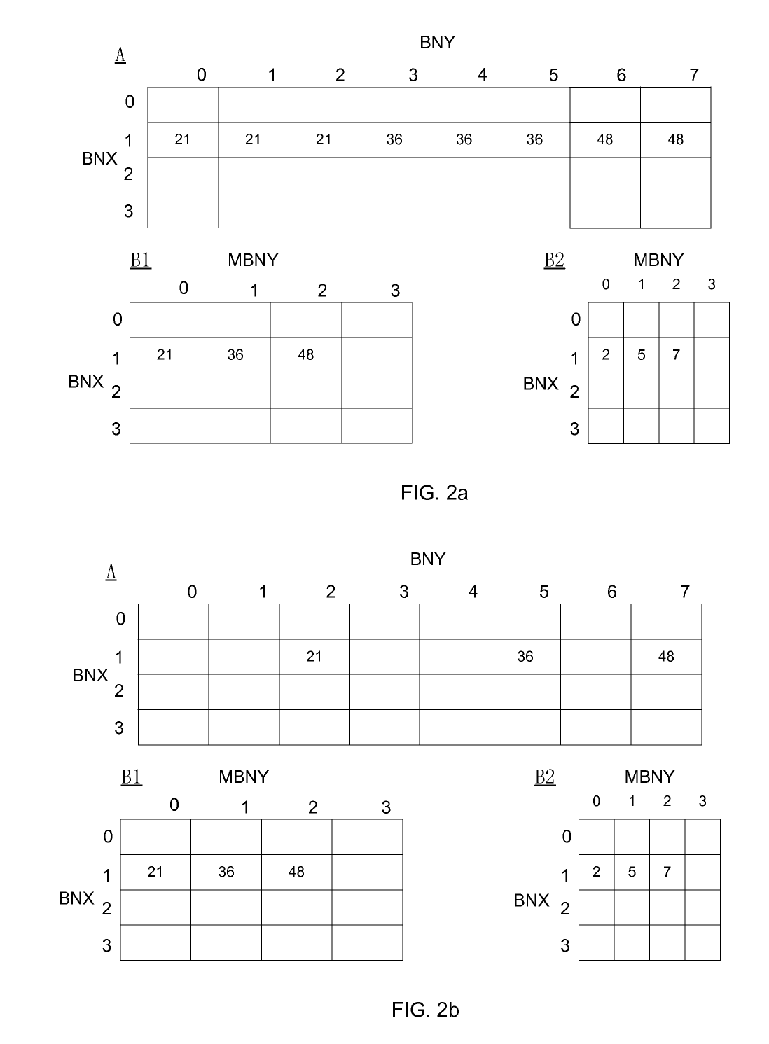

Please refer to FIG. 2a, which illustrates the storage format comparison of existing memory and the memory structure of this invention, to show the reduction of memory space of this invention.

Memory A of FIG. 2a, is the existing memory, whereas the second row has eight memory cells which are capable of storing 8 pieces of information. There are 3 unique pieces of information amongst the 8 pieces of information, “21”, “36” and “48”, while the other 5 pieces of information are redundant. Nevertheless, existing memory A , still needs eight memory cells to store the 8 pieces of information. However, only 3 memory cells of the first storage table B1 and 3 memory cells of the second storage table B2 are needed using the memory structure of the present invention. The memory space the present invention required is much less as the memory cell in second storage table B2 stores the representative value only, and is smaller in memory space as compared to that of the memory A and that of the first memory table B1. This is but one example of the application, memory space requirement can also be reduced through the memory structure of this embodiment in other situations, such as holes in memory A.

Please refer to FIG. 2b, which illustrates an alternative storage format comparison of existing memory and the memory structure of this invention, to show the reduction of memory space of this invention. Memory A of FIG. 2b, is the existing memory, whereas the second row has eight memory cells which are capable of storing 8 pieces of information. There are 3 unique pieces of information, “21”, “36” and “48”, while the other 5 memory cells are not used, are the holes. Nevertheless, existing memory A, still needs eight memory cells to store the 8 pieces of information. However, only 3 memory cells of the first storage table B1 and 3 memory cells of the second storage table B2 are needed using the memory structure of the present invention. As in the case of FIG. 2a, the memory space the present invention requires is much less as the memory cell in second storage table B2 stores the representative value only, and is smaller in memory space as compared to that of the memory A and that of the first memory table B1. Next, the storage, retrieve, and address of information using the first storage table, the second storage tables and the comparators are illustrated. Wherein the difference between retrieving and addressing lies in that retrieving operation outputs the information after obtaining the address, while addressing stores the obtained address for later usage, such as using it to retrieve information at a later time. In the subsequent description, the distinction between the two way of retrieving information are not emphasized.

It should be noted that in this and other embodiments of the present application, the representative value and BNY represent the same concept, the row address and BNX represent the same concept, the column address and MBNY represent the same concept. Here the row address and the representative value are the row address and the column address of the current memory, (i.e. memory A in FIG. 2a or FIG. 2b); therefore, the method of generating these addresses is prior art, and these addresses are presume known throughout this application.

Please refer back to FIG 1a. When information is being stored in this embodiment, it addresses a row of the first storage table 10 with the BNX value of the information, and writes the information into the first unoccupied cell on that row. Representative value BNY of the information is written into the corresponding memory cell in the second storage table 11 (i.e. the memory cell in the second storage table 11 is addressed by the same BNX and MBNY as the memory cell in first storage table 10), and thus completes the information storage.

Specifically, there is a write pointer pointing to the first unoccupied memory cell in each row of the first storage table 10 (initially the write pointer points to the first memory cell of the row). During information store, the information is stored into the memory cell pointed by the write pointer, then the write pointer moves to the next sequential memory cell, and thus implements “write the information into the first unoccupied cell on that row.”

In this embodiment, the address of the information retrieving is given as BNX and BNY. It is necessary to map the BNY into the MBNY so the corresponding information can be retrieved from the first storage table 10. Specifically, when retrieving information, the BNY value of the information address (BNX, BNY) are compared with BNY values stored in the second storage table 11, to acquire the corresponding MBNY value, the resulting address (BNX, MBNY) is sent to the first storage table 10. The first storage table 10 outputs the information addressed by (BNX, MBNY), and thus completes the information retrieving. This embodiment provides two types of correlations between the BNY value and the MBNY value:

1. Selecting the column address of the larger representative value as the column address corresponding to the representative value of the retrieving address if the said representative value falls between two representative values of two adjacent columns of the said second storage table; or

selecting the column address of the first column as the column address corresponding to the representative value of the retrieving address if the said representative value falls before the representative value of the first column of the said second storage table; or

selecting the last column address plus one as the column address corresponding to the representative value of the retrieving address if the said representative value falls after the representative value of the last column of the said second storage table.

2. Selecting the column address of the smaller representative value as the column address corresponding to the representative value of the retrieving address if the said representative value falls between two representative values of two adjacent columns of the said second storage table; or

selecting the column address of the first column minus one as the column address corresponding to the representative value of the retrieving address if the said representative value falls before the representative value of the first column of the said second storage table; or

selecting the last column address as the column address corresponding to the representative value of the retrieving address if the said representative value falls after the representative value of the last column of the said second storage table.

The aforementioned are only examples of correlation between BNY and MBNY, other correlations are also allowed. This application sets no limit on the types of correlations.

The aforementioned two correlations can be further explained with respect to FIG. 2a or FIG. 2b. For correlation 1, when repeated identical pieces of information are stored, the information is stored in the first storage table 10 only once, and at the same time, the largest BNY of the plural number of BNYs corresponding to the identical pieces of information is stored in the corresponding memory element of the second storage table 11. For correlation 2, when repeated identical pieces of information are stored, the information is stored in the first storage table 10 only once, and at the same time, the smallest BNY of the plural number of BNYs corresponding to the identical pieces of information is stored in the corresponding memory element of the second storage table 11.

Accordingly, this embodiment further illustrates the way that the BNY value is mapped to correspond to the MBNY value through employing comparators. Please refer to FIG. 1a, here the comparator 12 comprise 4 comparing units and 4 exclusive OR gates. The functionality of the comparator is to detect from the second storage table row indexed by the BNX, the column number (MBNY) of the first BNY which is larger than the BNY of the retrieving address. The 4 comparing units compare the BNY of the retrieving address with the 4 BNY from the second storage table row indexed by the BNX of the retrieving address. For correlation 1, the comparing unit outputs a ‘0’ when the BNY in the retrieving address is larger than the BNY value read from the second storage table, the comparing unit outputs a ‘1’ when the BNY in the retrieving address is less than or equal to the BNY value read from the second storage table. The output of the comparing units are sent to the 4 exclusive OR gates, wherein the output of the first comparing unit is sent to the first and second exclusive OR gates, the output of the second comparing unit is sent to the second and the third exclusive OR gates, the output of the third comparing unit is sent to the third and the forth exclusive OR gate, while the output of the forth comparing unit is sent to the forth exclusive OR gate. The other input of the first exclusive OR gate is ‘0’. The 4 exclusive OR gates outputs 4 ‘0’ or ‘1’, corresponding to the 4 columns of the first storage table 10. There is only one value ‘1’ out of the 4 exclusive OR results, the rest are all ‘0’s. The MBNY value can be select by the position of value ‘1’ of the exclusive OR results. The MBNY is ‘1’, if the ‘1’ exclusive OR result corresponds to the second memory element, while the MBNY is ‘2’, if the ‘1’ exclusive OR result corresponds to the third memory element. Therefore, information can be retrieved from the first storage table 10 based on the BNX value and the said MBNY value.

In addition, for correlation 2, refer to FIG lb, the comparator 13 comprise 4 comparing units and 4 exclusive OR gates. The function of the comparator here is to detect from the second storage table row indexed by the BNX, the column number (MBNY) of the last BNY which is less than the BNY of the retrieving address. The functionality of the 4 comparing units in comparator 13 is similar to that of the comparator 12 in FIG. 1a. The output of the comparing units are sent to the 4 exclusive OR gates, wherein the output of the first comparing unit is sent to the first exclusive OR gate, the output of the second comparing unit is sent to the first and second exclusive OR gate, the output of the third comparing unit is sent to the second and the third exclusive OR gate, while the output of the forth comparing unit is sent to the third and the forth exclusive OR gate. The other input of the forth exclusive OR gate is ‘1’. The 4 exclusive OR gates outputs 4 ‘0’ or ‘1’, corresponding to the 4 columns of the first storage table 10. There is only one value ‘1’ out of the 4 exclusive OR results, the rest are all ‘0’s. The MBNY value can be select by the position of value ‘1’ of the exclusive OR results. Selecting MBNY value based on the exclusive OR result and retrieve information from first storage table 10 are the same as in FIG. 1a, therefore are not repeated here.

### Embodiment 2

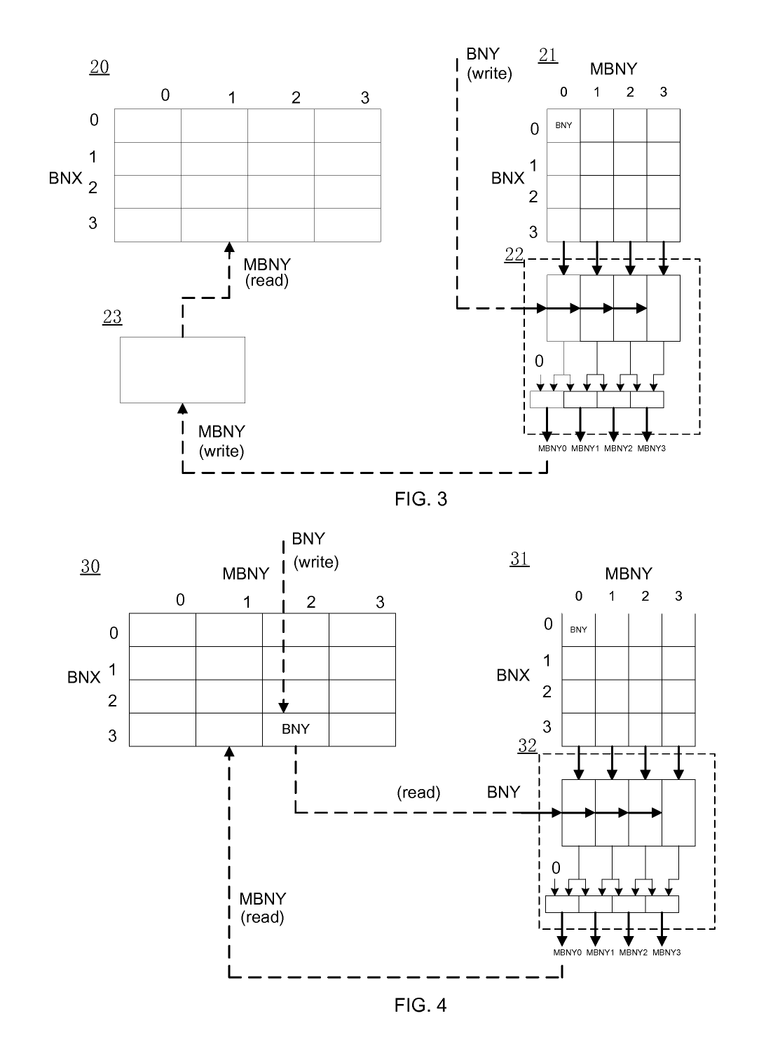

FIG. 3 illustrates a schematic diagram of another exemplary implementation for a storage structure implementation with the disclosed embodiments. As shown in FIG. 3, the said storage structure includes: the first storage table, the second storage table, comparator 22 and the third storage table 23, wherein, the structure and function of the said first storage table 20, the second storage table 1 and comparator 22 are the same as the first storage table, the second storage table 11 and comparator 12 in embodiment 1. That means, the difference between embodiment 2 and embodiment 1 is the said storage table further includes the third storage table 23. In this embodiment, the information storage is the same as described in embodiment 1. Therefore, please reference FIG. 1 for the information storage, which are not repeated herein.

In Embodiment 2, BNX and MBNY are employed as information retrieving address, wherein, BNY is translated prior to MBNY (e.g.: during the information store) and stored in the third storage table 23. The process of the said BNY translation to MBNY is the same as the described in embodiment 1, and therefore not repeated herein. In this embodiment 2, the MBNY value is stored in the third storage table 23 after translated from the corresponding BNY, by the time of information retrieving, the MBNY value stored in the third storage table 23 can be used to directly address the first storage table 20, by providing BNX and MBNY, and the said first storage table 20 outputs the corresponding information. It takes less time for embodiment 2 storage structure retrieving information comparing to that of embodiment 1. This is due to skipping the process of translating BNY to MBNY during retrieving. The MBNY can be directly accessed, and therefore, reduce the information retrieving time.

In embodiment two, it is capable of retrieving information from the first storage table 20 via another address which corresponds to the third storage table 23. For example, address of first storage table 20 (BNX, MBNY) can be retrieved from the third storage table 23 indexed by the another address, the said address of first storage table 20 then indexes the first storage table 20 to retrieve the information.

In addition, mapping of address BNX, MBNY into address BNX, BNY can be implemented through using the MBNY stored in a line in the third storage table 23 indexed by the BNX, the BNX, MBNY then indexes the second storage table 11 to retrieve the BNY value. The resulting BNX and BNY can be used to address a prior part (uncompressed) storage table.

### Embodiment 3

FIG. 4 illustrates a schematic diagram of an exemplary implementation for a storage structure implementation with the disclosed embodiment 3. As shown in FIG. 4, the storage structure may include a first storage table 30, a second storage table 31 and a comparator 32; wherein, said first storage table 30 includes a plurality of memory cells arranged in an array, each row of memory cells storing information in sequential order; the second storage table 31 includes a plurality of memory cells arranged in an array; the said second storage table 31 and the said first storage table 30 have the same number of rows and columns; the memory cell of the second storage table 31 stores the representative value of the corresponding cell of the first storage table 30; the comparators 32 compared the newly arrived representative values with the representative values stored in the second storage table 31; first storage table 30 outputs the information it stores corresponding to the newly arrived representative value based on the comparison result.

The difference between embodiment 3 and embodiment 1 is that the information stored in the first storage table 30 includes representative value, which is the BNX and BNY of the information being retrieved. During information retrieving, it translates the BNX, BNY address into BNX, MBNY address in the same way as in embodiment 1. The BNX and MBNY addresses the first storage table 30, retrieving the BNX and BNY address stored in 30. This new BNX, BNY is subsequently translated into a new BNX, MBNY, which addresses the first storage table 30 again to retrieve the next information.

### Embodiment 4

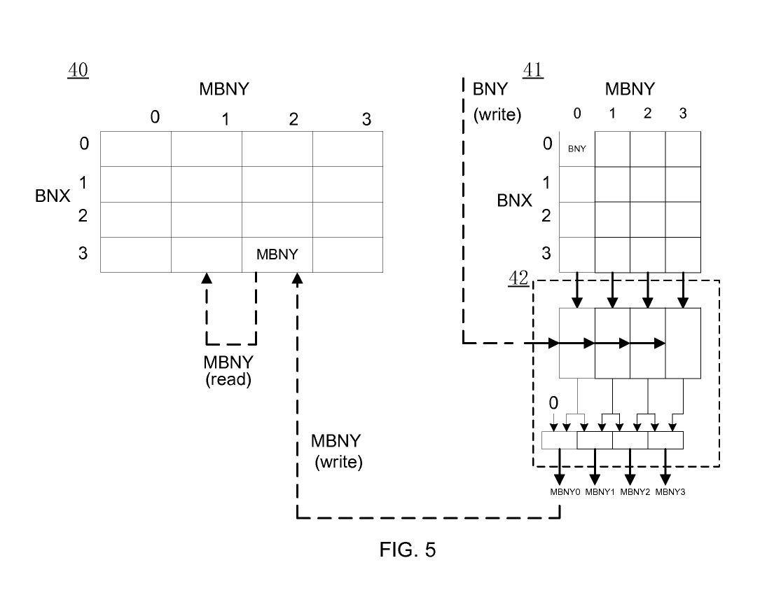

FIG. 5 illustrates a schematic diagram of another exemplary implementation for a storage structure implementation with the disclosed embodiment 4. As shown in FIG. 5, the storage structure may include a first storage table 40, a second storage table 41 and a comparator 42; wherein, said first storage table 40 includes a plurality of memory cells arranged in an array, each row of memory cells storing information in sequential order; the second storage table 41 includes a plurality of memory cells arranged in an array; the said second storage table 41 and the said first storage table 40 have the same number of rows and columns; the memory cell of the second storage table 41 stores the representative value of the corresponding cell of the first storage table 40; the comparators 42 compared the newly arrived representative values with the representative values stored in the second storage table 41; first storage table 40 outputs the information it stores corresponding to the newly arrived representative value based on the comparison result.

The difference between embodiment 4 and embodiment 2 is the content stored in the first storage table 40 is MBNY, that is the BNX and MBNY of the information being retrieved. During information retrieving, using BNX and MBNY address indexes the first storage table 40, retrieving the BNX and MBNY address stored in 40. This new BNX, MBNY subsequently addresses the first storage table 30 again to retrieve the next information. This way is faster in retrieving information comparing to the method employing BNX, BNY described in embodiment 3, because the process translating BNY to MBNY is skipped.

Specifically, the information stored in each memory cell of the first storage table 40 includes an address comprises BNX and MBNY, which points to a memory cell which stores the next piece of information. Hereon, named the information address original source address which comprises in the format of source BNX, source BNY, name the information address which indexes the first storage table 40 mapped source address in the format of source BNX, source MBNY. Further named the information address stored in one memory cell which points to another memory cell the original target address in the format of target BNX, target BNY, and name the information address which indexes the first storage table 40 mapped target address in the format of target BNX, target MBNY. When writing new information into a first storage table 40 line, mapped the information address into the mapped target address as afore described, then store the said mapped target address into the first un-occupied memory line in a first storage table 40 line which is indexed by the original source address BNX, then store the original source address BNY into the second storage table 41 cell corresponding to the said first un-occupied memory cell in the first storage table.

During information retrieving, the mapped source address (source BNX, source MBNY) retrieves information from the said first storage table 40. The said information comprises target address (target BNX, target MBNY) which points directly to the memory cell which contains the next piece of information. Therefore, the structure retrieves information through information stored in another memory cell without mapping. In addition, this track address not only point to this storage table, but also can point to other storage table. There is no limitation for track address point to which storage table.

In addition, the said track address can address not only the afore mentioned storage tables, but other types of storage tables. This disclosure does not limit the scope of which.

In this embodiment 4, MBNY can be mapped to BNY through addressing the second storage table 41 with BNX, MBNY, the BNY is in the retrieved memory cell content.

The resulting BNX, BNY can be used to retrieve information from uncompressed storage table. That is to say the branch instruction information stored in the afore mentioned first storage table 40 is the track address of the branch target instruction stored in another storage device/storage structure/storage table. This track address points to the next instruction. This track address can address other track table/storage table besides addressing this track table/storage themselves, this disclosure does not limit the scope. In summary, the storage processing structure, information storage, retrieve and addressing method disclosed by this application reduces the memory space requirement through store information in sequential order in the first storage table; and addresses and retrieves information utilizing the representative value stored in the corresponding memory cell of the second storage table, and therefore improve the speed of information retrieving and addressing.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

What is claimed is:

1. A storage processing structure, comprising:
a first storage table, a second storage table and comparators, wherein:
the first storage table comprises plurality storage elements organized in an array, the storage elements on each row stores information in a sequential order;
the second storage table comprises plurality storage elements organized in an array, the second storage table has a same number of rows and columns as the first storage table, a memory element in the second storage table stores a representative value of the corresponding memory element in the first storage table; and
the comparators compare newly arrived representative values with the representative values stored in the second storage table, the first storage table outputs the information corresponding to the newly arrived representative value based on the comparison result.

2. The structure according to claim 1, wherein:
the comparator compares the newly arrived representative value with the representative values stored in a row of the second table in parallel, and outputs a comparison result indicating “larger than”, “equal to” or “less than”; or indicating “larger than or equal” and “less than”; and
a column address corresponding to the newly arrived representative value is acquired by monitoring different comparison results of adjacent comparators.

3. The structure according to claim 2, wherein information stored in the first storage table is data or instructions.

4. The structure according to claim 1, wherein information is stored using address, the address comprises a row address and a representative value; the information is stored in a first available memory element in a first storage table row indexed by a row address;
and the representative value is stored in a corresponding second storage table element.

5. The structure according to claim 4, wherein the address of the information to be stored is stored in the first storage table.

6. The structure according to claim 4, wherein information is retrieved using address, the address comprises a row address and a representative value; the comparators compares the representative value in the address with representative values stored in a second storage table row indexed by the row address to generate a column address; and the first storage table outputs information in the memory element indexed by the row address and the column address.

7. The structure according to claim 6, wherein:
the column address of the larger representative value is selected as the column address corresponding to the representative value of the retrieving address if the representative value falls between two representative values of two adjacent columns of the second storage table; or
the column address of the first column is selected as the column address corresponding to the representative value of the retrieving address if the representative value falls before the representative value of the first column of the second storage table; or
a last column address plus one is selected as the column address corresponding to the representative value of the retrieving address if the representative value falls after the representative value of the last column of the second storage table.

8. The structure according to claim 6, wherein
the column address of the smaller representative value is selected as the column address corresponding to the representative value of the retrieving address if the representative value falls between two representative values of two adjacent columns of the second storage table; or
the column address of the first column minus one is selected as the column address corresponding to the representative value of the retrieving address if the representative value falls before the representative value of the first column of the second storage table; or
the last column address is selected as the column address corresponding to the representative value of the retrieving address if the representative value falls after the representative value of the last column of the second storage table.

9. The structure according to claim 4, wherein the address of the addressing information includes a row address and a representative value; the comparators compare the representative values with the representative values stored in the second storage table to acquire a column address; and
the row address and the column address are recorded for subsequent addressing.

10. The structure according to claim 9, wherein the representative value is retrieved from the second storage table based on the recorded row address and column address.

11. The structure according to claim 9, wherein the row address and column address are recorded in the first storage table.

12. The structure according to claim 9, further comprising:
a third storage table, wherein the row address and column address are recorded in the third storage table.

13. The structure according to claim 9, wherein:
the column address of the larger representative value is selected as the column address corresponding to the representative value of the retrieving address if the representative value falls between two representative values of two adjacent columns of the second storage table; or
the column address of the first column is selected as the column address corresponding to the representative value of the retrieving address if the representative value falls before the representative value of the first column of the second storage table; or
the last column address plus one is selected as the column address corresponding to the representative value of the retrieving address if the representative value falls after the representative value of the last column of the second storage table.

14. The structure according to claim 9, wherein
the column address of the smaller representative value is selected as the column address corresponding to the representative value of the retrieving address if the representative value falls between two representative values of two adjacent columns of the second storage table; or
the column address of the first column minus one is selected as the column address corresponding to the representative value of the retrieving address if the representative value falls before the representative value of the first column of the second storage table; or
the last column address is selected as the column address corresponding to the representative value of the retrieving address if the representative value falls after the representative value of the last column of the second storage table.

15. The structure according to claim 10, wherein:
the first storage table is a track table, a memory element of the track table stores a track address of a branch target instruction of a branch instruction stored in a memory, and a number of column of the track table is less than a number of instructions each memory row stores; and
the second storage table is a mapping table, a memory element of the mapping table stores a representative value, which is the offset address of the branch instruction in the memory corresponding to a mapping table memory element.

16. The structure according to claim 10, wherein the row address corresponds to block address of instructions stored in the memory.

17. The structure according to claim 10, wherein the information stored in the memory element of the table includes memory address of memory element other than that of the track table.

18. An information storage method, comprising:
providing a first storage table and a second storage table, wherein the first storage table comprises plurality storage elements organized in an array, the second storage table comprises plurality storage elements organized in an array, the second storage table has a same number of rows and columns as in the first storage table; and
acquiring an address of information being stored, the address comprises a row address and a representative value, wherein the information is stored in the first available memory element in the first storage table row indexed by the row address,
wherein the memory element in the second storage table stores a representative value of the corresponding memory element in the first storage table.

19. The method according to claim 18, wherein the first storage table stores the address of the information being stored.

20. The method according to claim 19, further comprising:
acquiring original content of the information being stored, wherein the original content comprises a row address and a representative value;
providing comparators, wherein the comparators compare the representative value in the original value and the representative values stored in the second storage table to acquire a corresponding column address,
wherein the first storage table stores the row address and the column address of the information being stored.

21. The method according to claim 20, wherein:
the column address of the larger representative value is selected as the column address corresponding to the representative value of the original content if the representative value falls between two representative values of two adjacent columns of the second storage table; or
the column address of the first column is selected as the column address corresponding to the representative value of the original content if the representative value falls before the representative value of the first column of the second storage table; or
the last column address plus one is selected as the column address corresponding to the representative value of the original content if the representative value falls after the representative value of the last column of the second storage table.

22. The method according to claim 20, wherein:
the column address of the smaller representative value is selected as the column address corresponding to the original content of the retrieving address if the representative value falls between two representative values of two adjacent columns of the second storage table; or
the column address of the first column minus one is selected as the column address corresponding to the representative value of the original content if the representative value falls before the representative value of the first column of the second storage table; or
the last column address is selected as the column address corresponding to the representative value of the original content if the representative value falls after the representative value of the last column of the second storage table.

23. An information retrieving method, comprising:
providing a first storage table, a second storage table and comparators, wherein the first storage table comprises plurality storage elements organized in an array, and storage elements on each row of the first storage table stores information in a sequential order; wherein the second storage table comprises plurality storage elements organized in an array, the second storage table has a same number of rows and columns as in the first storage table, and a memory element in the second storage table stores a representative value of the corresponding memory element in the first storage table;
retrieving an address of information to be read, wherein the address comprises of a row address and a representative value;
comparing, by comparators, the representative value of the retrieved address with the representative values stored in the second storage table to acquire a column address; and
outputting, by the first storage table, the information corresponding to the row address in the retrieving address and the column address.

24. The method according to claim 23, wherein:
the column address of the larger representative value is selected as the column address corresponding to the representative value of the retrieving address if the representative value falls between two representative values of two adjacent columns of the second storage table; or
the column address of the first column is selected as the column address corresponding to the representative value of the retrieving address if the representative value falls before the representative value of the first column of the second storage table; or
the last column address plus one is selected as the column address corresponding to the representative value of the retrieving address if the representative value falls after the representative value of the last column of the second storage table.

25. The method according to claim 23, wherein
the column address of the smaller representative value is selected as the column address corresponding to the representative value of the retrieving address if the representative value falls between two representative values of two adjacent columns of the second storage table; or
the column address of the first column minus one is selected as the column address corresponding to the representative value of the retrieving address if the representative value falls before the representative value of the first column of the second storage table; or
the last column address is selected as the column address corresponding to the representative value of the retrieving address if the representative value falls after the representative value of the last column of the second storage table.

26. An information addressing method, comprising:
providing a first storage table, a second storage table and comparators, wherein the first storage table comprises plurality storage elements organized in an array, storage elements on each row of the stores information in sequential order; wherein the second storage table comprises plurality storage elements organized in an array, the second storage table has a same number of rows and columns as in the first storage table, and a memory element in the second storage table stores a representative value of the corresponding memory element in the first storage table;
acquiring an address of information to be read, wherein the address comprises of a row address and a representative value;
comparing, by the comparators, the representative value of the information address with the representative values stored in the second storage table to acquire a column address;
outputting, by the first storage table, the information corresponding to the row address in the retrieving address and the column address; and
recording the row address and the column address for subsequent addressing.

27. The method according to claim 26, wherein the representative value is retrieved from the second storage table based on the recorded row address and column address.

28. The method according to claim 26, wherein the row address and column address are recorded in the first storage table.

29. The method according to claim 26, wherein the method further comprises a third storage table; the row address and column address are recorded in the third storage table.

30. The method according to claim 26, wherein:
the column address of the larger representative value is selected as the column address corresponding to the representative value of the retrieving address if the representative value falls between two representative values of two adjacent columns of the second storage table; or
the column address of the first column is selected as the column address corresponding to the representative value of the retrieving address if the representative value falls before the representative value of the first column of the second storage table; or
the last column address plus one is selected as the column address corresponding to the representative value of the retrieving address if the representative value falls after the representative value of the last column of the second storage table.

31. The method according to claim 26, wherein:
the column address of the smaller representative value is selected as the column address corresponding to the representative value of the retrieving address if the representative value falls between two representative values of two adjacent columns of the second storage table; or
the column address of the first column minus one is selected as the column address corresponding to the representative value of the retrieving address if the representative value falls before the representative value of the first column of the second storage table; or
the last column address is selected as the column address corresponding to the representative value of the retrieving address if the representative value falls after the representative value of the last column of the second storage table.
